(19) United States
(12) Patent Application Publication
(10) Pub. No.: US 2013/0053513 A1
(43) Pub. Date: Feb. 28, 2013

(54) LIQUID CRYSTAL ALIGNMENT AGENT, AND LIQUID CRYSTAL ALIGNMENT FILM AND LIQUID CRYSTAL DISPLAY ELEMENT FORMED FROM THE LIQUID CRYSTAL ALIGNMENT AGENT

(71) Applicant: Tsung-Pei TSAI, Tainan City (TW)

(72) Inventor: Tsung-Pei TSAI, Tainan City (TW)

(73) Assignee: CHI MEI CORPORATION, Tainan City (TW)

(21) Appl. No.: 13/572,350

(22) Filed: Aug. 10, 2012

(30) Foreign Application Priority Data
Aug. 23, 2011 (TW) 100130163

(51) Int. Cl. C08L 79/08

(52) U.S. Cl. 524/592; 524/606

(57) ABSTRACT

A liquid crystal alignment agent includes a polymer composition (A) and a solvent (B) for dispersing the polymer composition (A). The polymer composition (A) is obtained by subjecting a diamine component (a) and a tetracarboxylic dianhydride component (b) to a polymerization reaction. The diamine component (a) includes at least one diamine compound (a-1) having a dipole moment up to 2.8D.

### CROSS-REFERENCE TO RELATED APPLICATION

This application claims priority of Taiwanese Application No. 100130163, filed on Aug. 23, 2011.

### BACKGROUND OF THE INVENTION

1. Field of the Invention

This invention relates to a liquid crystal alignment agent, more particularly to a liquid crystal alignment agent having improved coating performance and hydrophobicity. The invention also relates to a liquid crystal alignment film formed from the liquid crystal alignment agent, and a liquid crystal display element including the liquid crystal alignment film.

2. Description of the Related Art

The following are predominant types of liquid crystal display elements widely used in the art of a liquid crystal display device: nematic liquid crystal display elements, vertical alignment liquid crystal display elements, and thin film transistor liquid crystal display elements. With the increase in requirement for the display qualities of the liquid crystal display device, the liquid crystal display elements with high performance have been developed so that the requirement for the electric or display characteristics such as liquid crystal aligning properties, voltage holding ratio, and reduction of image sticking problem is stricter. Therefore, the properties and characteristics of the liquid crystal alignment agent affecting the performance of the liquid crystal display elements have been investigated.

JP 2006028098 discloses a vertical alignment liquid crystal display element having a high voltage holding ratio, and a phenylenediamine compound for making a liquid crystal alignment film for the liquid crystal display element. The phenylenediamine compound is represented by the following formula:

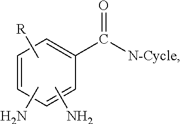

wherein N-cycle represents a non-aromatic N-containing heterocyclic group. The problems such as inferior voltage holding ratio and image sticking encountered in the conventional liquid crystal display element can be improved by using the aforesaid phenylenediamine compound for making a liquid crystal alignment film. However, the liquid crystal alignment film made from the phenylenediamine compound has insufficient moisture resistance which may result in inferior reliability for the liquid crystal display element made thereby.

### SUMMARY OF THE INVENTION

Therefore, a first object of the present invention is to provide a liquid crystal alignment agent which has improved coating performance and hydrophobicity.

A second object of the present invention is to provide a liquid crystal alignment film having improved hydrophobicity.

A third object of the present invention is to provide a liquid crystal display element having high voltage holding ratio and good reliability.

According to the first aspect of this invention, there is provided a liquid crystal alignment agent which includes a polymer composition (A) and a solvent (B) for dispersing the polymer composition (A). The polymer composition (A) is obtained by subjecting a diamine component (a) and a tetracarboxylic dianhydride component (b) to a polymerization reaction. The diamine component (a) includes at least one diamine compound (a-1) having a dipole moment up to 2.8D.

According to the second aspect of this invention, there is provided a liquid crystal alignment film formed from the liquid crystal alignment agent of this invention.

According to the third aspect of this invention, there is provided a liquid crystal display element including the liquid crystal alignment film of this invention.

### BRIEF DESCRIPTION OF THE DRAWING

Other features and advantages of the present invention will become apparent in the following detailed description of the preferred embodiments with reference to the accompanying drawing, of which:

FIG. 1 is a fragmentary schematic view of a preferred embodiment of a liquid crystal display element according to this invention.

### DETAILED DESCRIPTION OF THE PREFERRED EMBODIMENTS

### Liquid Crystal Alignment Agent

The liquid crystal alignment agent of the present invention includes a polymer composition (A) and a solvent (B) for dispersing the polymer composition (A). The polymer composition (A) is obtained by subjecting a diamine component (a) and a tetracarboxylic dianhydride component (b) to a polymerization reaction. The diamine component (a) includes at least one diamine compound (a-1) having a dipole moment up to 2.8D and preferably from 0.1D to 2.6D.

If the diamine component (a) for obtaining the polymer composition (A) does not contain the diamine compound (a-1) having a dipole moment up to 2.8D, the liquid crystal alignment film made from the liquid crystal alignment agent has inferior hydrophobicity, and the liquid crystal display element formed thereby has inferior reliability.

### Polymer Composition (A):

The polymer composition (A) includes a polyamic acid compound, a polyimide compound, a polyimide series block copolymer, or combinations thereof. The polyimide series block copolymer contains polyamic acid block copolymer, polyimide block copolymer, polyamic acid-polyimide block copolymer, or combinations thereof.

All of the polyamic acid compound, the polyimide compound, and the polyimide series block copolymer can be obtained by subjecting the diamine component (a) and the tetracarboxylic dianhydride component (b) to a polymerization reaction.

### Diamine Component (a):

The diamine compound (a-1) included in the diamine component (a) is preferably selected from the following compounds represented by formulas (1)-(15), and combinations thereof:

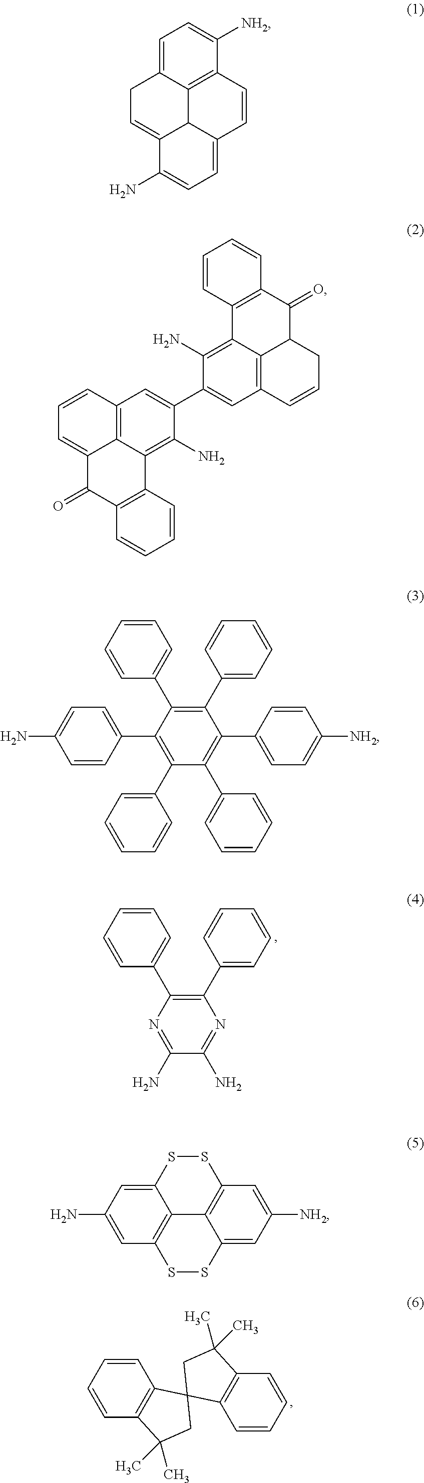

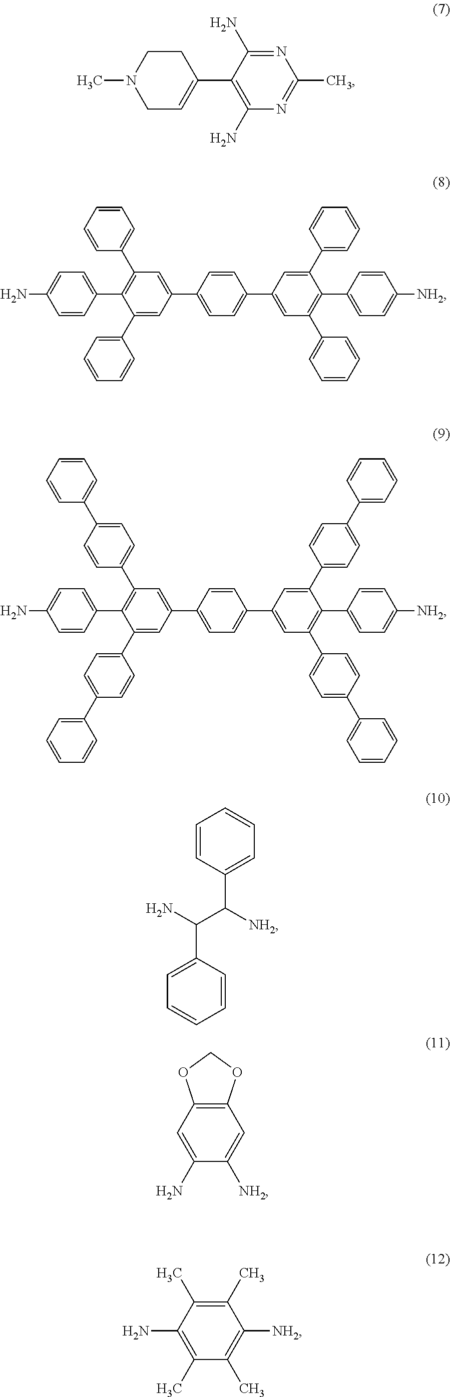

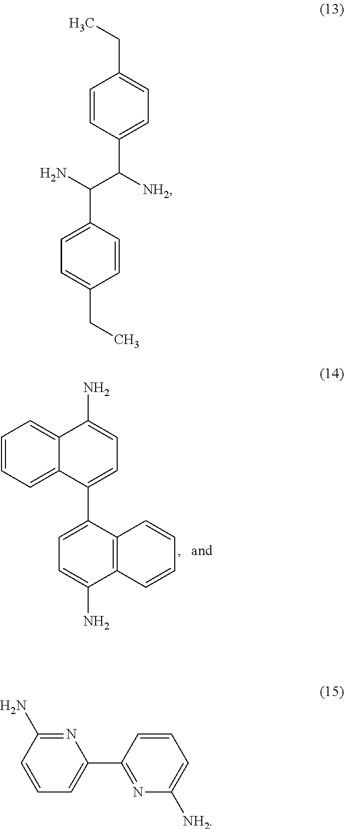 [SMILES: CCc1ccc(C(N)C(N)c2ccc(CC)cc2)cc1 ; Nc1ccc(-c2ccc(N)c3ccccc23)c2ccccc12 ; Nc1cccc(-c2cccc(N)n2)n1]

The dipole moment can be measured using a dielectric permittivity method, a molecular scattering method, a microwave spectroscopy method, or the like. In the present invention, the microwave spectroscopy method is used in which the dipole moment is determined from the split diffusion resulting from the Stark effect of a microwave absorption spectrum. The dipole moments of the diamine compounds represented by formulas (1)-(15) are shown in Table 1.

TABLE 1

| | Dipole |
|---|---|
| Compounds | moments |
| Formula | 1.208D |
| (1) | |
| Formula | 1.541D |
| (2) | |
| Formula | 0.984D |
| (3) | |
| Formula | 0.628D |
| (4) | |
| Formula | 0.591D |
| (5) | |
| Formula | 2.082D |
| (6) | |
| Formula | 1.788D |
| (7) | |
| Formula | 1.515D |
| (8) | |
| Formula | 0.868D |
| (9) | |
| Formula | 1.700D |
| (10) | |
| Formula | 0.917D |
| (11) | |
| Formula | 2.584D |
| (12) | |
| Formula | 1.955D |
| (13) | |
| Formula | 1.949D |
| (14) | |
| Formula | 0.670D |
| (15) | |

In addition to the diamine compound (a-1), the diamine component (a) can optionally include at least one diamine compound (a-2) having a dipole moment larger than 2.8D as long as the desirable effects of the present invention will not be negatively affected.

The diamine compound (a-1) is used in an amount ranging preferably from 20 to 80 moles, more preferably from 25 to 75 moles, and most preferably from 30 to 70 moles based on 100 moles of the diamine component (a). When the diamine compound (a-1) is used in the amount within the defined range, the liquid crystal display element formed thereby will have superior reliability.

Examples of the diamine compound (a-2) include, but are not limited to, 1,9-diamino-5-methylnonane (2.947D), isophorone diamine (3.556D), 4,4′-diaminodiphenyl sulfide (8.176D), 4,4′-diaminodiphenyl sulfone (6.295D), 3,3′-diaminodiphenyl sulfone (5.862D), 4,4′-diaminobenzanilide (4.118D), bis(3-aminophenyl)sulfoxide (5.095D), bis (4-aminophenyl)cyclohexyl phosphine oxide (11.887D), 2,2′-diaminobenzophenone (3.089D), 4,4′-diaminobenzophenone (3.103D), 2,2-bis[4-(4-aminophenoxy)phenyl]propane (3.350D), 2,2-bis[4-(4-aminophenoxy)phenyl]hexafluoropropane (6.445D), 2,2-bis(4-aminophenoxy)hexafluoropropane (4.067D), 2,2-bis[4-(4-aminophenoxy)phenyl]sulfone (6.228D), 4,4′-bis(4-aminophenoxy)biphenyl (3.335D), 1,3-bis(4-aminophenoxy)benzene (2.923D), 4,4′-(p-phenyleneisopropylidene)dianiline (3.874D), 4,4′-(m-phenyleneisopropylidene)dianiline (3.864D), 5,6-diamino-2,3-dicyanopyrazine (7.499D), 2,7-diaminodibenzofuran (2.974D), 2,5-diamino-1,3,4-thiadiazole (3.341D), 2,6-diaminopurine (4.943D), 5,6-diamino-1,3-dimethyluracil (4.138D), 3,5-diamino-1,2,4-triazole (3.700D), 3,8-diamino-6-phenylphenanthridine (3.354D), compounds represented by following formulas (16) to (21), and combinations thereof:

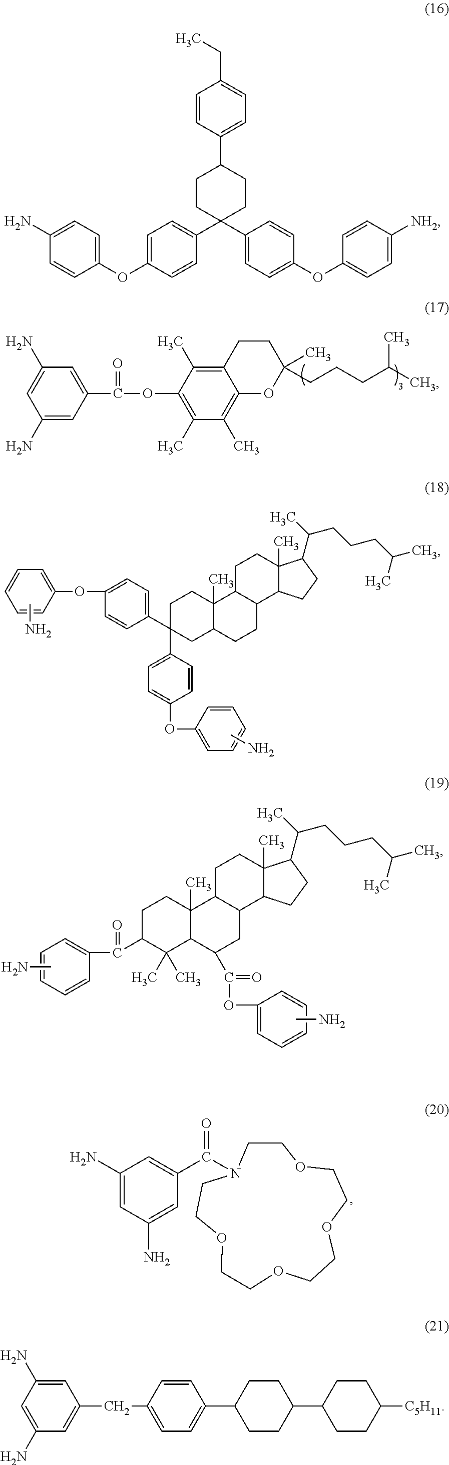

The dipole moments of the diamine compounds represented by formulas (16)-(21) are shown in Table 2.

TABLE 2

| | Dipole |
|---|---|
| Compounds | moments |
| Formula | 3.892D |
| (16) | |
| Formula | 6.088D |
| (17) | |
| Formula | 2.923D |
| (18) | |
| Formula | 4.016D |
| (19) | |
| Formula | 6.951D |
| (20) | |
| Formula | 3.027D |
| (21) | |

### Tetracarboxylic Dianhydride Component (b):

Tetracarboxylic dianhydride component (b) suitable for the present invention includes aliphatic tetracarboxylic dianhydride (b-1), alicyclic tetracarboxylic dianhydride (b-2), and aromatic tetracarboxylic dianhydride (b-3). These tetracarboxylic dianhydride compounds may be used alone or in admixture of two or more.

Examples of aliphatic tetracarboxylic dianhydride (b-1) include, but are not limited to, ethanetetracarboxylic dianhydride and butanetetracarboxylic dianhydride.

Examples of alicyclic tetracarboxylic dianhydride (b-2) include, but are not limited to, 1,2,3,4-cyclobutanetetracarboxylic dianhydride, 1,2-dimethyl-1,2,3,4-cyclobutanetetracarboxylic dianhydride, 1,3-dimethyl-1,2,3,4-cyclobutanetetracarboxylic dianhydride, 1,3-dichloro-1,2,3,4-cyclobutanetetracarboxylic dianhydride, 1,2,3,4-tetramethyl-1,2,3,4-cyclobutanetetracarboxylic dianhydride, 1,2,3,4-cyclopentanetetracarboxylic dianhydride, 1,2,4,5-cyclohexanetetracarboxylic dianhydride, 3,3′,4,4′-dicyclohexanetetracarboxylic dianhydride, cis-3,7-dibutylcycloheptyl-1,5-diene-1,2,5,6-tetracarboxylic dianhydride, 2,3,5-tricarboxylcyclopentylacetic dianhydride, and bicyclo[2.2.2]-octa-7-ene-2,3,5,6-tetracarboxylic dianhydride.

Examples of aromatic tetracarboxylic dianhydride (b-3) include, but are not limited to, 3,4-dicarboxy-1,2,3,4-tetrahydronaphthalene-1-succinic acid dianhydride, pyromellitic dianhydride, 3,3′,4,4′-benzophenonetetracarboxylic dianhydride, 3,3′,4,4′-biphenylsulfonetetracarboxylic dianhydride, 1,4,5,8-naphthalenetetracarboxylic dianhydride, 2,3,6,7-naphthatenetetracarboxylic dianhydride, 3,3′-4,4′-biphenylethanetetracarboxylic dianhydride, 3,3′,4,4′-dimethyldiphenylsilanetetracarboxylic dianhydride, 3,3′,4,4′-tetraphenylsilanetetracarboxylic dianhydride, 1,2,3,4-furantetracarboxylic dianhydride, 4,4′-bis(3,4-dicarboxyphenoxy)diphenylsulfide dianhydride, 4,4′-bis(3,4-dicarboxyphenoxy)diphenylsulfone dianhydride, 4,4′-bis(3,4-dicarboxyphenoxy)diphenylpropane dianhydride, 3,3′,4,4′-perfluoroisopropylidenediphthalic dianhydride, 3,3′,4,4′-diphenyltetracarboxylic dianhydride, bis(phthalic acid)phenylphosphine oxide dianhydride, p-phenylene-bis(triphenylphthalic acid) dianhydride, m-phenylene-bis(triphenylphthalic acid) dianhydride, bis(triphenylphthalic acid)-4,4′-diphenylether dianhydride, bis(triphenylphthalic acid)-4,4′-diphenylmethane dianhydride, ethylene glycol-bis(anhydrotrimellitate), propylene glycol-bis(anhydrotrimellitate), 1,4-butanediol-bis(anhydrotrimellitate), 1,6-hexanediol-bis(anhydrotrimellitate), 1,8-octanediol-bis(anhydrotrimellitate), 2,2-bis(4-hydroxyphenyl)propane-bis(anhydrotrimellitate), 2,3,4,5-tetrahydrofurantetracarboxylic dianhydride, 1,3,3a,4,5,9b-hexahydro-5-(tetrahydro-2,5-dioxo-3-furanyl)-naphtho[1,2-c]-furan-1,3-dione, 1,3,3a,4,5,9b-hexahydro-5-methyl-5-(tetrahydro-2,5-dioxo-3-furanyl)-naphtho[1,2-c]-furan-1,3-dione, 1,3,3a,4,5,9b-hexahydro-5-ethyl-5-(tetrahydro-2,5-dioxo-3-furanyl)-naphtho[1,2-c]-furan-1,3-dione, 1,3,3a,4,5,9b-hexahydro-7-methyl-5-(tetrahydro-2,5-dioxo-3-furanyl)-naphtho[1,2-c]-furan-1,3,-dione, 1,3,3a,4,5,9b-hexahydro-7-ethyl-5-(tetrahydro-2,5-dioxo-3-furanyl)-naphtho[1,2-c]-furan-1,3,-dione, 1,3,3a,4,5,9b-hexahydro-8-methyl-5-(tetrahydro-2,5-dioxo-3-furanyl)-naphtho[1,2-c]-furan-1,3-dione, 1,3,3a,4,5,9b-hexahydro-8-ethyl-5-(tetrahydro-2,5-dioxo-3-furanyl)-naphtho[1,2-c]-furan-1,3-dione, 1,3,3a,4,5,9b-hexahydro-5,8-dimethyl-5-(tetrahydro-2,5-dioxo-3-furanyl)-naphtho[1,2-c]-furan-1,3-dione, and 5-(2,5-dioxotetrahydrofuranyl)-3-methyl-3-cyclohexene-1,2-dicarboxylic dianhydride.

In addition to the aforesaid examples of the tetracarboxylic dianhydride, other examples of the tetracarboxylic dianhydride useful for the present invention include the compounds represented by the following formulas (I-1)-(I-6):

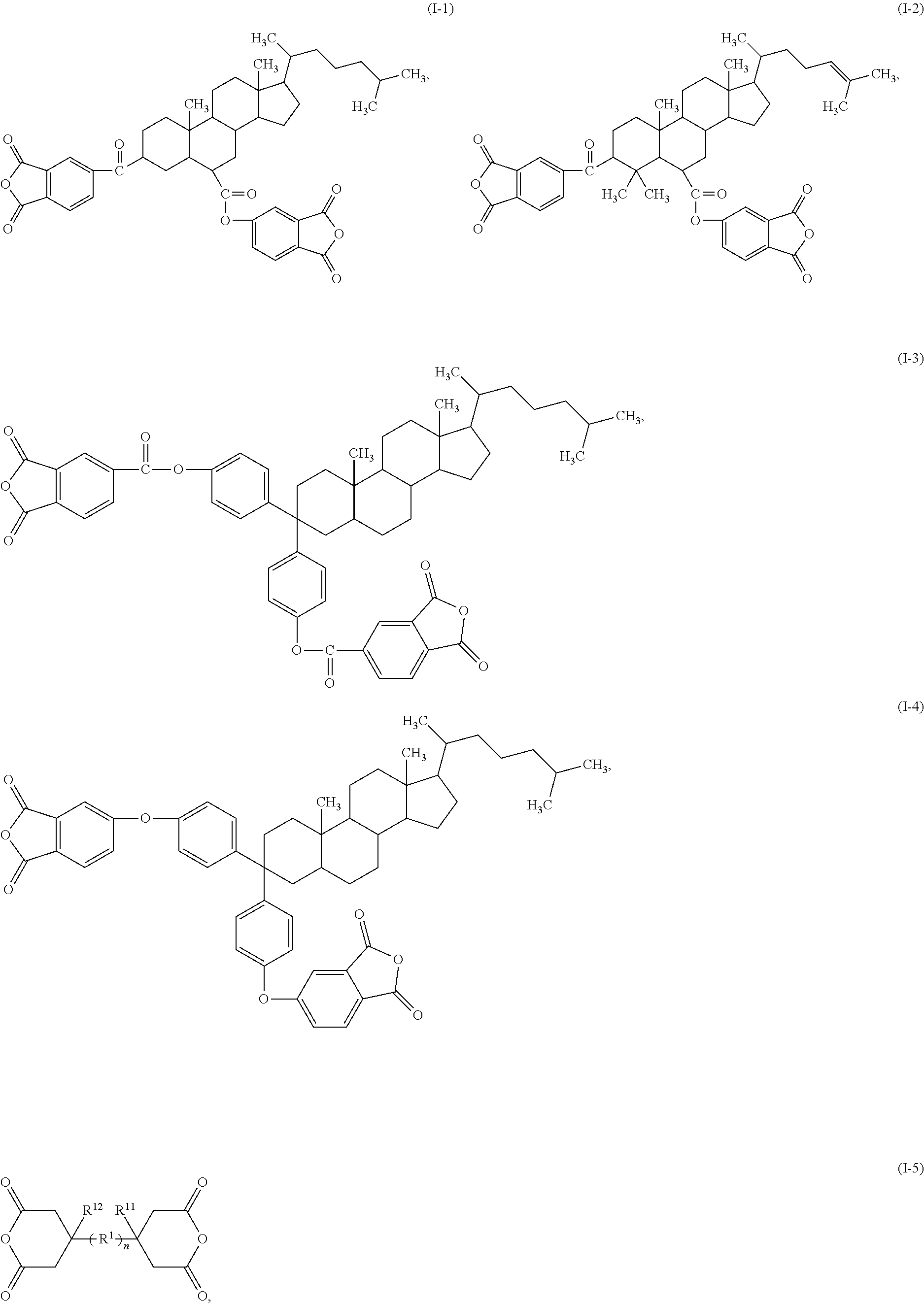

wherein R¹ represents a divalent group having an aromatic ring structure; n represents an integer ranging from 1 to 2; and R¹¹ and R¹² may be the same or different, and independently represent hydrogen or an alkyl group, and

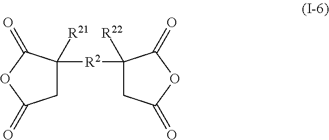

wherein R² represents a divalent group having an aromatic ring structure; and R²¹ and R²² may be the same or different, and independently represent hydrogen or an alkyl group.

Preferably, the tetracarboxylic dianhydride represented by formula (I-5) is selected from

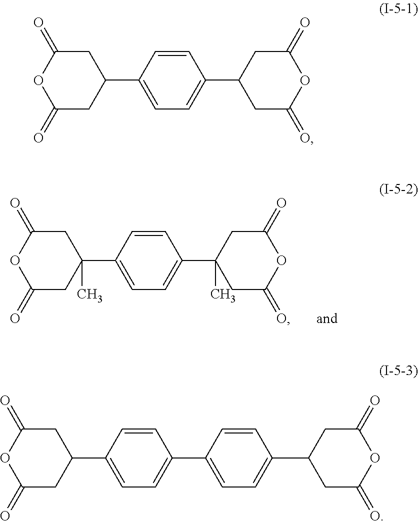 [SMILES: O=C1CC(c2ccc(C3CC(=O)OC(=O)C3)cc2)CC(=O)O1 ; CC1(c2ccc(C3(C)CC(=O)OC(=O)C3)cc2)CC(=O)OC(=O)C1 ; O=C1CC(c2ccc(-c3ccc(C4CC(=O)OC(=O)C4)cc3)cc2)CC(=O)O1]

Preferably, the tetracarboxylic dianhydride represented by formula (I-6) is

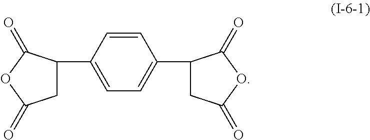 [SMILES: O=C1CC(c2ccc(C3CC(=O)OC3=O)cc2)C(=O)O1]

Preferred examples of the tetracarboxylic dianhydride component (b) suitable for the present invention include, but are not limited to, 1,2,3,4-cyclobutanetetracarboxylic dianhydride, 1,2,3,4-cyclopentanetetracarboxylic dianhydride, 2,3,5-tricarboxycyclopentylacetic dianhydride, 3,4-dicarboxy-1,2,3,4-tetrahydronaphthalene-1-succinic acid dianhydride, pyromellitic dianhydride, 3,3′,4,4′-benzophenonetetracarboxylic dianhydride, and 3,3′,4,4′-diphenylsulfonetetracarboxylic dianhydride.

### Preparation of Polyamic Acid Compound:

The polyamic acid compound useful in the present invention is obtained by subjecting the diamine component (a) and the tetracarboxylic dianhydride component (b) to a polycondensation reaction. The polycondensation reaction is conducted in an organic solvent at a temperature ranging from 0 to 100° C. for a period ranging from 1 to 24 hours to obtain a reaction solution. The reaction solution is distilled under a reduced pressure in a distiller to obtain the polyamic acid compound. Alternatively, the reaction solution can be treated by pouring it into a large amount of poor solvent to obtain a precipitate, which is then dried under a reduced pressure to obtain the polyamic acid compound.

The tetracarboxylic dianhydride component (b) is used in an amount ranging preferably from 20 to 200 moles, more preferably from 30 to 120 moles based on 100 moles of the diamine component (a).

The organic solvent for the polycondensation reaction may be the same as or different from the solvent (B) used in the liquid crystal alignment agent. Furthermore, there is no particular limitation to the organic solvent for the polycondensation reaction as long as the organic solvent is able to dissolve the reactants and the products. Examples of the organic solvent for the polycondensation reaction include, but are not limited to, (1) aprotic polar solvents, such as N-methyl-2-pyrrolidone, N,N-dimethylacetamide, N,N-dimethylformamide, dimethylsulfoxide, γ-butyrolactone, tetramethylurea, hexamethylphosphoric acid triamide, and the like; and (2) phenolic solvents, such as m-cresol, xylenol, phenol, halogenated phenols, and the like.

The organic solvent for the polycondensation reaction is used in an amount preferably from 200 to 2,000 parts by weight and more preferably from 300 to 1,800 parts by weight based on 100 parts by weight of a combination of the diamine component (a) and the tetracarboxylic dianhydride component (b).

The aforementioned organic solvent for the polycondensation reaction can be used in combination with a poor solvent in such an amount that does not cause precipitation of the formed polymer. Examples of the poor solvent include, but are not limited to, (1) alcohols, such as methyl alcohol, ethyl alcohol, isopropyl alcohol, cyclohexanol, ethylene glycol, propylene glycol, 1,4-butanediol, triethylene glycol, or the like; (2) ketones, such as acetone, methyl ethyl ketone, methyl isobutyl ketone, cyclohexanone, or the like; (3) esters, such as methyl acetate, ethyl acetate, butyl acetate, diethyl oxalate, diethyl malonate, ethylene glycol ethyl ether acetate, or the like; (4) ethers, such as diethyl ether, ethylene glycol methyl ether, ethylene glycol ethyl ether, ethylene glycol n-propyl ether, ethylene glycol i-propyl ether, ethylene glycol n-butyl ether, ethylene glycol dimethyl ether, diethylene glycol dimethyl ether, or the like; (5) halogenated hydrocarbons, such as dichloromethane, 1,2-dichloroethane, 1,4-dichlorobutane, trichloroethane, chlorobenzene, o-dichlorobenzene, or the like; and (6) hydrocarbons, such as tetrahydrofuran, hexane, heptane, octane, benzene, toluene, xylene, or the like; or combinations thereof. The examples of the poor solvent may be used alone or in admixture of two or more.

The poor solvent is used in an amount preferably from 0 to 60 parts by weight and more preferably from 0 to 50 parts by weight based on 100 parts by weight of the diamine component (a).

### Polyimide Compound:

The polyimide compound useful in the present invention is obtained by subjecting a diamine component and a tetracarboxylic dianhydride component to a dehydration/ring-closure (imidization) reaction, which is conducted by dissolving the diamine component and the tetracarboxylic dianhydride component in an organic solvent, and heating in the presence of a dehydrating agent and an imidization catalyst to implement the dehydration/ring-closing reaction. The diamine component and the tetracarboxylic dianhydride component for the imidization reaction may be the same as the diamine component and the tetracarboxylic dianhydride component for obtaining the polyamic acid compound.

The organic solvent for the imidization reaction may be the same as the solvent (B) used in the liquid crystal alignment agent. The organic solvent for the imidization reaction is used in an amount preferably from 200 to 2,000 parts by weight and more preferably from 300 to 1,800 parts by weight based on 100 parts by weight of the polyamic acid compound.

Heating temperature for the imidization reaction is generally from 30 to 200° C., preferably from 40 to 150° C. If the heating temperature of the imidization reaction is lower than 30° C., then the dehydration ring-closing reaction cannot be fully implemented and the imidization extent is unsatisfactory. If the reaction temperature exceeds 200° C., then the weight average molecular weight of the obtained polyimide compound is reduced.

When the imidization extent is less than 90%, the liquid crystal alignment agent produced from the polyimide compound has a better coating performance.

Examples of the dehydrating agent suitable for the imidization reaction include acid anhydride compounds, such as acetic anhydride, propionic anhydride, trifluoroacetic anhydride, or combinations thereof. The used amount of the dehydrating agent is preferably from 0.01 to 20 moles per mole of the polyamic acid compound. Examples of the catalyst suitable for the imidization reaction include pyridine compounds, such as pyridine, trimethylpyridine, dimethylpyridine, or the like; and tertiary amines, such as triethylamine, or the like. The used amount of the catalyst is preferably from 0.5 to 10 moles per mole of the dehydrating agent.

### Polyimide Series Block Copolymer:

The polyimide series block copolymer suitable for the present invention comprises polyamic acid block copolymer, polyimide block copolymer, polyamic acid-polyimide block copolymer, or combinations thereof.

The polyimide series block copolymer is obtained by further polycondensation reaction of a starting material which includes at least one of the aforesaid polyamic acid compounds and/or at least one of the aforesaid polyimide compounds and which can further include a diamine component and/or a tetracarboxylic dianhydride component. The diamine component and the tetracarboxylic dianhydride component used for obtaining the polyimide series block copolymer may be the same as the diamine component and the tetracarboxylic dianhydride component used for the preparation of the polyamic acid compound, and the organic solvent used for obtaining the polyimide series block copolymer may be the same as the solvent (B) used for the preparation of the liquid crystal alignment agent. The organic solvent for obtaining the polyimide series block copolymer is used in an amount preferably from 200 to 2,000 parts by weight and more preferably from 300 to 1,800 parts by weight based on 100 parts by weight of the starting material used for obtaining the polyimide series block copolymer.

In the polycondensation reaction for the polyimide series block copolymer, the reaction temperature is generally from 0 to 200° C. and preferably from 0 to 100° C.

Preferably, non-limiting examples of the starting material used for obtaining the polyimide series block copolymer include: (1) first and second polyamic acid compounds which are different from each other in structures and terminal groups thereof; (2) first and second polyimide compounds which are different from each other in structures and terminal groups thereof; (3) a polyamic acid compound and a polyimide compound which are different from each other in structures and terminal groups thereof; (4) a polyamic acid compound, a diamine component, and a tetracarboxylic dianhydride component, wherein at least one of the diamine component and the tetracarboxylic dianhydride component is structurally different from the one used in the polycondensation reaction for the polyamic acid compound; (5) a polyimide compound, a diamine component, and a tetracarboxylic dianhydride component, wherein at least one of the diamine component and the tetracarboxylic dianhydride component is structurally different from the one used in the polycondensation reaction for the polyimide compound; (6) a polyamic acid compound, a polyimide compound, a diamine component, and a tetracarboxylic dianhydride component, wherein at least one of the diamine component and the tetracarboxylic dianhydride component is structurally different from the ones used in the polycondensation reaction for the polyamic acid compound and the polycondensation reaction for the polyimide compound; (7) first and second polyamic acid compounds, a diamine component, and a tetracarboxylic dianhydride component, wherein the first and second polyamic acid compounds are structurally different from each other; (8) first and second polyimide compounds, a diamine component, and a tetracarboxylic dianhydride component, wherein the first and second polyimide compounds are structurally different from each other; (9) first and second polyamic acid compounds and a diamine component, wherein the first and second polyamic acid compounds have anhydride terminal groups and are structurally different from each other; (10) first and second polyamic acid compounds and a tetracarboxylic dianhydride component, wherein the first and second polyamic acid compounds have amino terminal groups and are structurally different from each other; (11) first and second polyimide compounds and a diamine component, wherein the first and second polyimide compounds have anhydride terminal groups and are structurally different from each other; and (12) first and second polyimide compounds and a tetracarboxylic dianhydride component, wherein the first and second polyimide compounds have amino terminal groups and are structurally different from each other.

Preferably, the polyamic acid compound, the polyimide compound, and the polyimide series block copolymer used in the present invention can also be the polymers which are terminal-modified after an adjustment of molecular weight thereof as long as the desirable effects of the present invention are not reduced. The terminal-modified polymers can be used to improve the coating performance of the liquid crystal alignment agent. The process for synthesizing the terminal-modified polymers involves adding a monofunctional compound to the reaction system during the polycondensation reaction for the polyamic acid compound and/or the polyimide compound and/or the polyimide series block copolymer.

Examples of the monofunctional compound include, but are not limited to, (1) monoanhydride compounds, such as maleic anhydride, phthalic anhydride, itaconic anhydride, n-decyl succinic anhydride, n-dodecyl succinic anhydride, n-tetradecyl succinic anhydride, n-hexadecyl succinic anhydride, and the like; (2) monoamine compounds, such as aniline, cyclohexylamine, n-butylamine, n-amylamine, n-hexylamine, n-heptylamine, n-octylamine, n-nonylamine, n-decylamine, n-undecylamine, n-dodecylamine, n-tridecylamine, n-tetradecylamine, n-pentadecylamine, n-hexadecylamine, n-heptadecylamine, n-octadecylamine, n-eicosylamine, and the like; and (3) monoisocyariate compounds, such as phenyl isocyanate, naphthylisocyanate, and the like.

### Solvent (B):

Preferably, the solvent (B) used in the liquid crystal alignment agent of the present invention is selected from N-methyl-2-pyrrolidone, γ-butyrolactone, γ-butyrolactam, 4-hydroxy-4-methyl-2-pentanone, ethylene glycol monomethyl ether, butyl lactate, butyl acetate, methyl methoxypropionate, ethyl ethoxypropionate, ethylene glycol methyl ether, ethylene glycol ethyl ether, ethylene glycol n-propyl ether, ethylene glycol isopropyl ether, ethylene glycol n-butyl ether, ethylene glycol dimethyl ether, ethylene glycol ethyl ether acetate, diglycol dimethyl ether, diglycol diethyl ether, diglycol monomethyl ether, diglycol monoethyl ether, diglycol monomethyl ether acetate, diglycol monoethyl ether acetate, N,N-dimethylformamide, N,N-dimethylethanamide, and the like. The examples of the solvent (B) may be used alone or in admixture of two or more.

### Additives:

The additives such as functional silane containing compounds or epoxy group containing compounds may be added to the liquid crystal alignment agent of the present invention so as to improve adhesion of the liquid crystal alignment agent to the substrate to be applied as long as the intended properties of the liquid crystal alignment agent are not impaired. The additives may be used alone or in admixture of two or more.

Examples of the functional silane containing compounds include, but are not limited to, 3-aminopropyltrimethoxysilane, 3-aminopropyltriethoxysilane, 2-aminopropyltrimethoxysilane, 2-aminopropyltriethoxysilane, N-(2-aminoethyl)-3-aminopropyltrimethoxysilane, N-(2-aminoethyl)-3-aminopropylmethyldimethoxysilane, 3-ureidopropyltrimethoxysilane, 3-ureidopropyltriethoxysilane, N-ethoxycarbonyl-3-aminopropyltrimethoxysilane, N-ethoxycarbonyl-3-aminopropyltriethoxysilane, N-triethoxysilylpropyltriethylenetriamine, N-trimethoxysilylpropyltriethylenetriamine, 10-trimethoxysilyl-1,4,7-triazadecane, 10-triethoxysilyl-1,4,7-triazadecane, 9-trimethoxysilyl-3,6-diazanonylacetate, 9-triethoxysilyl-3,6-diazanonylacetate, N-benzyl-3-aminopropyltrimethoxysilane, N-benzyl-3-aminopropyltriethoxysilane, N-phenyl-3-aminopropyltrimethoxysilane, N-phenyl-3-aminopropyltriethoxysilane, N-bis(oxyethylene)-3-aminopropyltrimethoxysilane, and N-bis(oxyethylene)-3-aminopropyltriethoxysilane.

Examples of the epoxy group containing compounds include, but are not limited to, ethylene glycol diglycidyl ether, polyethylene glycol diglycidyl ether, propylene glycol diglycidyl ether, tripropylene glycol diglycidyl ether, polypropylene glycol diglycidyl ether, neopentyl glycol diglycidyl ether, 1,6-hexanediol diglycidyl ether, glycerin diglycidyl ether, 2,2-dibromo-neopentyl glycol diglycidylether, 1,3,5,6-tetragylcidyl-2,4-hexanediol, N,N,N′,N′-tetragylcidyl-m-xylenediamine, 1,3-bis(N,N-digylcidylaminomethyl)cyclohexane, N,N,N′,N′-tetragylcidyl-4,4′-diaminodiphenylmethane, N,N-gylcidyl-p-glycidoxyaniline, 3-(N-allyl-N-glycidyl)aminopropyltrimethoxysilane, and 3-(N,N-diglycidyl)aminopropyltrimethoxysilane.

There is no specific limitation to the method for preparing the liquid crystal alignment agent of the present invention. The general mixing method can be used. For example, the liquid crystal alignment agent of the present invention can be made by mixing at least one polyamic acid compound, and/or at least one polyimide compound, and/or at least one polyimide series block copolymer to obtain the polymer composition (A), which is then added with the solvent (B) and optional additives at a temperature ranging from 0 to 200° C. and preferably from 20 to 60° C. followed by stirring until the polymer composition (A) is dissolved in the solvent (B).

In order to provide better coating performance for the liquid crystal alignment agent, the solvent (B) used for preparing the liquid crystal alignment agent is in an amount ranging preferably from 1,000 to 2,000 parts by weight and more preferably from 1,200 to 2,000 parts by weight based on 100 parts by weight of the polymer composition (A).

The additives are in an amount ranging preferably from 0.5 to 50 parts by weight and more preferably from 1 to 45 parts by weight based on 100 parts by weight of the polymer composition (A).

In order to provide better coating performance for the liquid crystal alignment agent and to provide better reliability for the liquid crystal display element, the surface tension of the liquid crystal alignment agent of the present invention ranges preferably from 30 N/m to 60 N/m and more preferably from 35 N/m to 55 N/m at 25° C. When the surface tension of the liquid crystal alignment agent of the present invention is within the range defined above, the surface unevenness of the liquid crystal alignment film affecting the liquid crystal arrangement caused by droplets can be alleviated, and the reliability of the liquid crystal display element can be enhanced as well.

### Liquid Crystal Alignment Film:

The prepared liquid crystal alignment agent is applied to a substrate by a roller coating method, a spinner coating method, a printing method, an ink-jet method, or the like to form a coating film. The coating film is then treated by a pre-bake treatment, a post-bake treatment and an alignment treatment to obtain a liquid crystal alignment film.

The pre-bake treatment causes the solvent to volatilize. Temperature for the pre-bake treatment is generally from 30 to 120° C., preferably from 40 to 110° C., and more preferably from 50 to 100° C.

The post-bake treatment is carried out to conduct a dehydration/ring-closure (imidization) reaction. Temperature for the post-bake treatment is generally from 150 to 300° C., preferably from 180 to 280° C., and more preferably from 200 and 250° C.

The alignment treatment is carried out by rubbing the coating film in a certain direction with a roller wound with a cloth made of nylon, rayon, or cotton fiber according to the requirements.

In order to provide better hydrophobicity for the liquid crystal alignment film and to provide better reliability for the liquid crystal display element, the liquid crystal alignment film has a moisture content ranging preferably from 2 wt % to 7 wt %, more preferably from 2 wt % to 6 wt %, and most preferably from 2 wt % to 5 wt % based on 100 wt % of the liquid crystal alignment film.

In order to provide better reliability for the liquid crystal display element, the liquid crystal alignment film has surface specific resistivity preferably not less than 5×10¹³Ω and more preferably from 5×10¹³Ω to 1×10¹⁷Ω. When the surface specific resistivity of the liquid crystal alignment film is within the range defined above, the adsorption of metal ions on the liquid crystal alignment film affecting the liquid crystal arrangement can be reduced, and the reliability of the liquid crystal display element can be enhanced as well.

### Liquid Crystal Display Element:

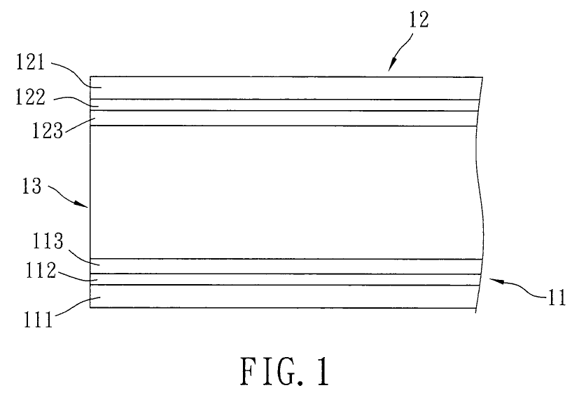

Referring to FIG. 1, a preferred embodiment of a liquid crystal display element according to this invention includes a first unit 11, a second unit 12 spaced apart from the first unit 11, and a liquid crystal unit 13 disposed between the first unit 11 and the second unit 12.

The first unit 11 includes a first substrate 111, a first conductive film 112 formed on the first substrate 111, and a first liquid crystal alignment film 113 formed on the first conductive film 112 and opposite to the first substrate 111.

The second unit 12 includes a second substrate 121, a second conductive film 122 formed on the second substrate 121, and a second liquid crystal alignment film 123 formed on the second conductive film 122 and opposite to the second substrate 121. The first and second liquid crystal alignment films 113, 123 face toward each other.

The first and second substrates 111, 121 suitable for the present invention are made of a transparent material, for example, alkali-free glass, soda-lime glass, hard glass (Pyrex glass), quartz glass, polyethylene terephthalate, polybutylene terephthalate, polyether sulphone, polycarbonate, or the like commonly used in liquid crystal display devices. The first and second conductive films 112, 122 may be a film made of tin oxide (SnO₂), indium oxide-tin oxide (In₂O₃—SnO₂), or the like.

The first and second liquid crystal alignment films 113, 123 are respectively a film made of the liquid crystal alignment agent of the present invention, and are used for providing the liquid crystal unit 13 with a pretilt angle. The liquid crystal unit 13 can be activated by an electric field cooperatively produced by the first and second conductive films 112, 122.

Preferably, the liquid crystal unit 13 is made of a nematic liquid crystal material having negative dielectric anisotropy, examples of which include, but are not limited to, Shift Base liquid crystals, azoxy liquid crystals, biphenyl liquid crystals, phenylcyclohexane liquid crystals, ester liquid crystals, terphenyl liquid crystals, biphenylcyclohexane liquid crystals, pyrimidine liquid crystals, dioxane liquid crystals, bicyclooctane liquid crystals, and cubane liquid crystals. Furthermore, ferroelectric liquid crystals, such as cholesterol liquid crystals, for example, cholesteryl chloride, cholesteryl nonanoate, cholesteryl carbonate, or the like, chiral agents sold under the trade names C-15, CB-15 (manufactured by Merck Company) may be added to the above liquid crystals, as required.

### EXAMPLES

The following examples are provided to illustrate the preferred embodiments of the invention, and should not be construed as limiting the scope of the invention.

### Preparation of Polyamic Acid Compound

### Synthesis Example 1

A 500 ml four-necked conical flask equipped with a nitrogen inlet, a stirrer, a condenser and a thermometer was purged with nitrogen, and was added with a diamine compound having the aforesaid formula (I) (referred as to a-1-1 hereinafter, 2.32 g, 0.01 mole), a diamine compound having the aforesaid formula (16) (referred as to a-2-1 hereinafter, 22.19 g, 0.04 mole), and N-methyl-2-pyrrolidone (referred as to NMP hereinafter, 80 g). Stirring was conducted at room temperature until a-1-1 and a-2-1 were dissolved. Pyromellitic dianhydride (referred to as b-3-1 hereinafter, 10.91 g, 0.05 mole) and NMP (20 g) were then added, and reaction was conducted for 2 hours at room temperature. The reaction solution was then poured into water (1500 ml) to precipitate a polymer. The polymer obtained after filtering was washed with methanol and filtered three times, and was dried in a vacuum oven at 60° C. to obtain a polyamic acid compound (A-1-1).

### Synthesis Examples 2 to 5

Polyamic acid compounds (A-1-2˜A-1-5) were prepared according to the method of Synthesis Example 1 except that the diamine compounds and the tetracarboxylic dianhydride compounds shown in Table 3 were used instead of the diamine compounds and the tetracarboxylic dianhydride compound used in Synthesis Example 1.

### Preparation of Polyimide Compound

### Synthesis Example 6

A 500 ml four-necked conical flask equipped with a nitrogen inlet, a stirrer, a condenser and a thermometer was purged with nitrogen, and was added with a diamine compound having the aforesaid formula (5) (referred as to a-1-5 hereinafter, 7.71 g, 0.025 mole), a diamine compound having the aforesaid formula (17) (referred as to a-2-3 hereinafter, 5.34 g, 0.010 mole), 4,4′-diaminodiphenylsulfone (referred as to a-2-5 hereinafter, 1.86 g, 0.0075 mole), 4,4′-diaminobenzophenone (referred as to a-2-6 hereinafter, 1.59 g, 0.0075 mole), and NMP (80 g). Stirring was conducted at room temperature until a-1-5, a-2-3, a-2-5, and a-2-6 were dissolved. b-3-1 (5.46 g, 0.025 mole), 2,3,5-tricarboxycyclopentylacetic dianhydride (referred as to b-2-2 hereinafter, 5.60 g, 0.025 mole), and NMP (20 g) were then added, and reaction was conducted for 6 hours at room temperature. NMP (97 g), acetic anhydride (5.61 g), and pyridine (19.75 g) were then added. Stirring was continued for 2 hours at 60° C. to conduct imidization reaction. The reaction solution was then poured into water (1500 ml) to precipitate a polymer. The polymer obtained after filtering was washed with methanol and filtered three times, and was dried in a vacuum oven at 60° C. to obtain a polyimide compound (A-2-1).

### Synthesis Examples 7 to 14

Polyimide compounds (A-2-2˜A-2-9) were prepared according to the method of Synthesis Example 6 except that the diamine compounds and the tetracarboxylic dianhydride compounds shown in Table 3 were used instead of the diamine compounds and the tetracarboxylic dianhydride compounds used in Synthesis Example 6.

### Preparation of Polyimide Series Block Copolymer

### Synthesis Example 15

The polyamic acid compound (A-1-1) and the polyimide compound (A-2-3) obtained without precipitation were mixed, and were stirred at 60° C. for 6 hours to conduct a copolymerization reaction. The reaction solution was then poured into water (1500 ml) to precipitate a polymer. The polymer obtained after filtering was washed with methanol and filtered three times, and was dried in a vacuum oven at 60° C. to obtain a polyamic acid-polyimide block copolymer (A-3-1).

### Synthesis Example 16

The polyamic acid compound (A-1-5) and the polyimide compound (A-2-5) obtained without precipitation were mixed, and were stirred at 60° C. for 6 hours to conduct a copolymerization reaction. The reaction solution was then poured into water (1500 ml) to precipitate a polymer. The polymer obtained after filtering was washed with methanol and filtered three times, and was dried in a vacuum oven at 60° C. to obtain a polyamic acid-polyimide block copolymer (A-3-2).

TABLE 3

| | | | Synthesis Examples | | | | | | | | | | | | | |
|---|---|---|---|---|---|---|---|---|---|---|---|---|---|---|---|---|
| Components | | | 1 | 2 | 3 | 4 | 5 | 6 | 7 | 8 | 9 | 10 | 11 | 12 | 13 | 14 |
| (mole %) | | | A-1-1 | A-1-2 | A-1-3 | A-1-4 | A-1-5 | A-2-1 | A-2-2 | A-2-3 | A-2-4 | A-2-5 | A-2-6 | A-2-7 | A-2-8 | A-2-9 |
| Diamine | Up to | a-1-1 | 20 | — | — | — | — | — | — | 30 | — | — | 100 | 50 | — | — |
| component | 2.8D | a-1-2 | — | 25 | — | — | — | — | — | 40 | — | — | — | 50 | — | — |
| (a) | (a-1) | a-1-3 | — | — | 30 | — | — | — | — | — | — | — | — | — | — | — |
| | | a-1-4 | — | — | — | 40 | — | — | — | — | — | — | — | — | — | — |
| | | a-1-5 | — | — | — | — | — | 50 | — | — | 40 | — | — | — | — | — |
| | | a-1-6 | — | — | — | — | — | — | 60 | — | 40 | — | — | — | — | — |
| | | a-1-7 | — | — | — | — | — | — | — | — | — | — | — | — | 30 | — |
| | Larger | a-2-1 | 80 | 75 | — | — | — | — | — | — | — | — | — | — | — | — |
| | than | a-2-2 | — | — | 20 | 10 | — | — | — | 20 | — | 20 | — | — | 70 | — |
| | 2.8D | a-2-3 | — | — | — | 20 | — | 20 | 15 | 10 | 20 | — | — | — | — | — |
| | (a-2) | a-2-4 | — | — | — | — | 90 | — | — | — | — | — | — | — | — | — |
| | | a-2-5 | — | — | 50 | — | 10 | 15 | — | — | — | — | — | — | — | — |
| | | a-2-6 | — | — | — | 30 | — | 15 | 25 | — | — | 80 | — | — | — | 10 |
| | | a-2-7 | — | — | — | — | — | — | — | — | — | — | — | — | — | 90 |

| | | | | | | | | | | | | | | | |
|---|---|---|---|---|---|---|---|---|---|---|---|---|---|---|---|
| Tetracarboxylic | b-3-1 | 100 | — | — | — | — | 50 | — | 100 | — | — | 100 | — | 100 | — |
| dianhydride | b-2-1 | — | 100 | — | 50 | — | — | 50 | — | 100 | — | — | 100 | — | 50 |
| component | b-2-2 | — | — | 100 | — | 100 | 50 | 50 | — | — | 100 | — | — | — | 50 |
| (b) | | | | | | | | | | | | | | | |

Notes:
a-1-1: a compound represented by formula (1)
a-1-2: a compound represented by formula (2)
a-1-3: a compound represented by formula (3)
a-1-4: a compound represented by formula (4)
a-1-5: a compound represented by formula (5)
a-1-6: a compound represented by formula (6)
a-1-7: a compound represented by formula (12)
a-2-1: a compound represented by formula (16)
a-2-2: a compound represented by formula (21)
a-2-3: a compound represented by formula (17)
a-2-4: a compound represented by formula (20)
a-2-5: 4,4′-diaminodiphenylsulfone
a-2-6: 4,4′-diaminobenzophenone
a-2-7: 1,3-bis(4-aminophenoxy)benzene
b-3-1: Pyromellitic dianhydride
b-2-1: 1,2,3,4-cyclobutanetetracarboxylic dianhydride
b-2-2: 2,3,5-tricarboxylcyclopentylacetic dianhydride

### Preparation of Liquid Crystal Alignment Agent, Liquid Crystal Alignment Film, and Liquid Crystal Display Element

### Example 1

100 parts by weight (dry weight) of the polyamic acid compound (A-1-1) of Synthesis Example 1 and 10 parts by weight of N,N,N′,N′-tetraglycidyl-4,4′-diaminodiphenylmethane (manufactured by Vantico, Int., Brewster, N.Y., trade name: MY721, referred to as C-1 hereinafter) were stirred in a co-solvent consisting of NMP (750 parts by weight) and ethylene glycol n-butyl ether (750 parts by weight) at room temperature to form a liquid crystal alignment agent.

The liquid crystal alignment agent was coated onto two glass substrates each having an ITO (indium-tin-oxide) conductive film using a printing machine (manufactured by Japan Nissha Printing Co., Ltd., Model S15-036), after which the glass substrates coated with the alignment agent solution were pre-baked on a heating plate at a temperature of 100° C. for 5 minutes, and were then post-baked in a hot air circulation baking oven at a temperature of 220° C. for 30 minutes. The thickness of the film obtained after post-baking was measured to be around 800±200 Å using a film thickness measuring device (manufactured by KLA-Tencor, Model Alpha-step 500). An alignment (rubbing) process was then carried out on the surface of the film using a rubbing machine (Model RM02-11 manufactured by Iinuma Gauge Mfg. Co., Ltd.). The stage moving rate was 50 mm/sec. When rubbing, a hair push-in length was 0.3 mm, and was unidirectionally rubbed once. Two glass substrates each coated with the liquid crystal alignment film were thus manufactured by the aforementioned steps.

Thermo-compression adhesive agent was applied to one glass substrate, and spacers of 4 μm were sprayed on the other glass substrate. The two glass substrates were aligned and bonded together in a vertical direction, and then 10 kg of pressure was applied using a thermocompressor to carry out thermocompression at 150° C. Liquid crystal was poured using a liquid crystal pouring machine (manufactured by Shimadzu Corporation, Model ALIS-100X-CH), ultraviolet light was then used to harden a sealant to seal the liquid crystal injection hole, and an annealing treatment was conducted in an oven at 60° C. for 30 minutes, thereby manufacturing a liquid crystal display element.

The liquid crystal alignment agent, the liquid crystal alignment film and the liquid crystal display element obtained thereby were evaluated according to the following evaluation methods. The evaluation results are shown in Table 4.

### Examples 2-12 and Comparative Examples 1-4

Examples 2-12 and Comparative Examples 1-4 were conducted in a manner identical to Example 1 using the polymer compositions, the solvents, and the additives shown in Table 4 to prepare the liquid crystal alignment agents, the liquid crystal alignment films, and the liquid crystal display elements. The additive C-2 is N,N-glycidyl-p-glycidoxyaniline (manufactured by Japan Epoxy Resins, trade name: JER630SLD). The additive C-3 is N,N,N′,N′-tetraglycidyl-m-xylene diamine (manufactured by Mitsubishi Gas Company Inc., trade name: GA-240).

The liquid crystal alignment agents, the liquid crystal alignment films, and the liquid crystal display elements thus obtained were evaluated according to the following evaluation methods. The results are shown in Table 4.

### [Evaluation Items]

### 1. Surface Tension:

The surface tension of each of the liquid crystal alignment agents prepared in Examples 1-12 and Comparative Examples 1-4 was determined using a surface tension meter (a CBUP A1 surface tensiometer manufactured by Kyowa Kagaku Co.), and was recorded in N/m.

### 2. Surface Specific Resistance:

Each of the liquid crystal alignment films prepared in Examples 1-12 and Comparative Examples 1-4 was modulated at a temperature of 23° C. and a relative humidity of 50% for 7 days using a disk electrode (manufactured by Yokogawa Hewlett-Packard Ltd., Japan, trade name: 16008B, inner diameter: 50 mm, and outer diameter: 70 mm), and the surface specific resistance was then measured using a high resistance meter (manufactured by Yokogawa Hewlett-Packard Ltd., Japan, Model no. 4329A) at an applied voltage of 100 V.

### 3. Moisture Content:

Each of the liquid crystal alignment films prepared in Examples 1-12 and Comparative Examples 1-4 was placed at an atmospheric environment for 168 hours, and the wet weight (W₁) thereof was measured and recorded. Each of the liquid crystal alignment films prepared in Examples 1-12 and Comparative Examples 1-4 was then disposed in a vacuum oven at a temperature of 100° C. for 48 hours, and the dry weight (W₂) thereof was measured and recorded. The moisture content was determined from the wet weight (W₁) and the dry weight (W₂).

### 4. Hydrophobicity:

Each of the liquid crystal alignment agents prepared in Examples 1-12 and Comparative Examples 1-4 was applied on a glass substrate using a spin coater, and was then baked at a temperature of 80° C. for 1 minute and then at a temperature of 180° C. for 1 hour to form a film having a thickness of 600 Å. A water droplet of 1 μL was dripped on a top surface of the film, and the contact angle of the droplet on the top surface of the film was measured. Evaluation was conducted according to the following standards:

◯contact angle≧100°

Δ: 100°>contact angle≧50°

X: contact angle<50°

### 5. Coating Performance:

Each of the liquid crystal alignment films prepared in Examples 1-12 and Comparative Examples 1-4 was observed using a microscope to determine whether the defects such as pin holes or precipitates appeared on each of the liquid crystal alignment films. Evaluation was conducted according to the following standards:

◯: a smooth film surface without precipitate

Δ: a film surface with a small amount of pin holes and a small amount of precipitate

X: a film surface with a significant amount of pin holes and a significant amount of precipitate

### 6. Voltage Holding Ratio:

The voltage holding ratio of each of the liquid crystal display elements prepared in Examples 1-12 and Comparative Examples 1-4 was measured using an electrical measuring machine (manufactured by TOYO Corporation, Model 6254). A voltage of 4 volts was applied for 120 microseconds. The applied voltage was held for 16.67 milliseconds. After the applied voltage was cut off for 16.67 milliseconds, the voltage holding ratio was measured. Each of the liquid crystal display elements prepared in Examples 1-12 has a voltage holding ratio more than 92%, which meets the requirement for the art. However, the voltage holding ratio of each of the liquid crystal display elements prepared in Comparative Examples 1-4 was unsatisfactory.

### 7. Reliability:

The reliability of the liquid crystal display elements prepared in Examples 1-12 and Comparative Examples 1-4 was carried out at a temperature of 65° C. and relative humidity of 85% for 120 hours, and then the voltage holding ratio was measured using the aforesaid evaluation method. The reliability of the liquid crystal display elements was evaluated according to the following standards:

⊚: Voltage holding ratio≧94%

◯: 94%>Voltage holding ratio≧92%

Δ: 92%>Voltage holding ratio≧90%

X: Voltage holding ratio<90%

TABLE 4

| Components | | Examples | | | | | | | | | | | | Comparative Examples | | | |
|---|---|---|---|---|---|---|---|---|---|---|---|---|---|---|---|---|---|
| (pbw*) | | 1 | 2 | 3 | 4 | 5 | 6 | 7 | 8 | 9 | 10 | 11 | 12 | 1 | 2 | 3 | 4 |
| Polymer | A-1-1 | 100 | — | — | — | — | — | — | — | — | — | — | — | — | — | — | — |
| composition | A-1-2 | — | 100 | — | — | — | — | — | — | — | — | — | — | — | — | — | — |
| (A) | A-1-3 | — | — | 100 | — | — | — | — | — | — | — | — | — | — | — | — | — |
| | A-1-4 | — | — | — | 100 | — | — | — | — | — | — | — | — | — | — | — | — |
| | A-1-5 | — | — | — | — | — | — | — | — | — | — | — | — | 100 | — | — | — |
| | A-2-1 | — | — | — | — | 100 | — | — | — | — | — | — | — | — | — | — | — |
| | A-2-2 | — | — | — | — | — | 100 | — | — | — | — | — | — | — | — | — | — |
| | A-2-3 | — | — | — | — | — | — | 100 | — | — | — | — | — | — | — | — | — |
| | A-2-4 | — | — | — | — | — | — | — | 100 | — | — | — | — | — | — | — | — |
| | A-2-5 | — | — | — | — | — | — | — | — | — | — | — | — | — | 100 | — | — |
| | A-2-6 | — | — | — | — | — | — | — | — | — | 100 | — | — | — | — | — | — |
| | A-2-7 | — | — | — | — | — | — | — | — | — | — | 100 | — | — | — | — | — |
| | A-2-8 | — | — | — | — | — | — | — | — | — | — | — | 100 | — | — | — | — |
| | A-2-9 | — | — | — | — | — | — | — | — | — | — | — | — | — | — | — | 100 |
| | A-3-1 | — | — | — | — | — | — | — | — | 100 | — | — | — | — | — | — | — |
| | A-3-2 | — | — | — | — | — | — | — | — | — | — | — | — | — | — | 100 | — |
| Solvent | B-1 | 750 | 850 | — | 1500 | 750 | 850 | — | 600 | — | 750 | 850 | — | 750 | 750 | 750 | 750 |
| (B) | B-2 | 750 | — | 750 | — | 750 | — | 750 | 600 | 750 | 750 | — | 750 | 750 | 750 | 750 | 750 |
| | B-3 | — | 750 | 900 | — | — | 750 | 900 | 300 | 750 | — | 750 | 900 | — | — | — | — |
| Additives | C-1 | 10 | — | — | 5 | — | 5 | — | — | — | 10 | — | — | 10 | — | — | 10 |
| (C) | C-2 | — | 10 | — | 5 | 5 | — | — | 10 | 10 | — | 10 | — | — | 10 | — | — |
| | C-3 | — | — | 10 | — | 5 | 5 | — | — | — | — | — | — | — | — | 10 | — |
| Surface tension (N/m) | | 59 | 56 | 55 | 50 | 48 | 42 | 34 | 33 | 48 | 31 | 32 | 55 | 61 | 58 | 62 | 59 |
| Moisture content (%) | | 7 | 6.5 | 6.3 | 5.3 | 5 | 4.5 | 3.2 | 2 | 5.1 | 2 | 2.1 | 6.4 | 11 | 10 | 10 | 10 |
| Resistance (10¹³ Ω) | | 5.5 | 11 | 15 | 20 | 35 | 45 | 48 | 49 | 34 | 55 | 52 | 14 | 1.1 | 3.1 | 2.3 | 2.9 |
| Evaluation | Hydrophobicity | ◯ | ◯ | ◯ | ◯ | ◯ | ◯ | ◯ | ◯ | ◯ | ◯ | ◯ | ◯ | X | X | X | X |
| result | Coating | ◯ | ◯ | ◯ | ◯ | ◯ | ◯ | ◯ | ◯ | ◯ | ◯ | ◯ | ◯ | Δ | X | X | X |
| | performance | | | | | | | | | | | | | | | | |
| | Reliability | ◯ | ⊚ | ⊚ | ⊚ | ⊚ | ⊚ | ⊚ | ⊚ | ⊚ | ⊚ | ⊚ | ⊚ | X | X | X | X |

pbw: part by weight
B-1: NMP
B-2: butylcellosolve
B-3: N,N-dimethylacetamide
C-1: MY721
C-2: JER630LSD
C-3: GA-240

As shown in Table 4, in Examples 1-12, the diamine component (a) for obtaining the polymer composition (A) contains the diamine compound (a-1) having a dipole moment ranging from 0.591D to 2.548D, the liquid crystal alignment agents obtained in Examples 1-12 have better hydrophobicity, and the liquid crystal display elements made from the liquid crystal alignment agents have superior reliability. The liquid crystal alignment agents obtained in Examples 1-11 have surface tension ranging from 31 N/m to 59 N/M, moisture content ranging from 2% to 7%, and resistance ranging from 5.5×10¹³Ω to 49×10¹³Ω. The reliability of the liquid crystal display elements thus obtained can be enhanced.

However, in Comparative Examples 1-4, the diamine component (a) for obtaining the polymer composition (A) contains the diamine compound (a-1) having a dipole moment larger than 2.8D, the liquid crystal alignment agents obtained in Examples 1-12 have worse hydrophobicity, and the liquid crystal display elements made from the liquid crystal alignment agents have inferior reliability. Specifically, in Comparative Example 1, the diamine component (a) for obtaining the polymer composition (A) contains the phenylenediamine compound (i.e., the compound represented by formula (20)) disclosed in JP 2006028098.

It has thus been shown that the moisture resistance of the liquid crystal alignment film of the present invention can be improved so that the reliability of the liquid crystal display elements thus obtained can be enhanced.

In view of the aforesaid, the hydrophobicity of a liquid crystal alignment agent can be improved using a diamine component containing a diamine compound having a dipole moment up to 2.8D to obtain the polymer composition for forming the liquid crystal alignment agent. The liquid crystal display element thus formed has a superior voltage holding ratio and better reliability.

While the present invention has been described in connection with what are considered the most practical and preferred embodiments, it is understood that this invention is not limited to the disclosed embodiments but is intended to cover various arrangements included within the spirit and scope of the broadest interpretation and equivalent arrangements.

What is claimed is:

1. A liquid crystal alignment agent, comprising:
a polymer composition (A) obtained by subjecting a diamine component (a) and a tetracarboxylic dianhydride component (b) to a polymerization reaction; and
a solvent (B) for dispersing said polymer composition (A),
wherein said diamine component (a) includes at least one diamine compound (a-1) having a dipole moment of up to 2.8D.

2. The liquid crystal alignment agent as claimed in claim 1, wherein said dipole moment of said diamine compound (a-1) ranges from 0.1D to 2.6D.

3. The liquid crystal alignment agent as claimed in claim 1, wherein said diamine compound (a-1) is selected from the group consisting of: 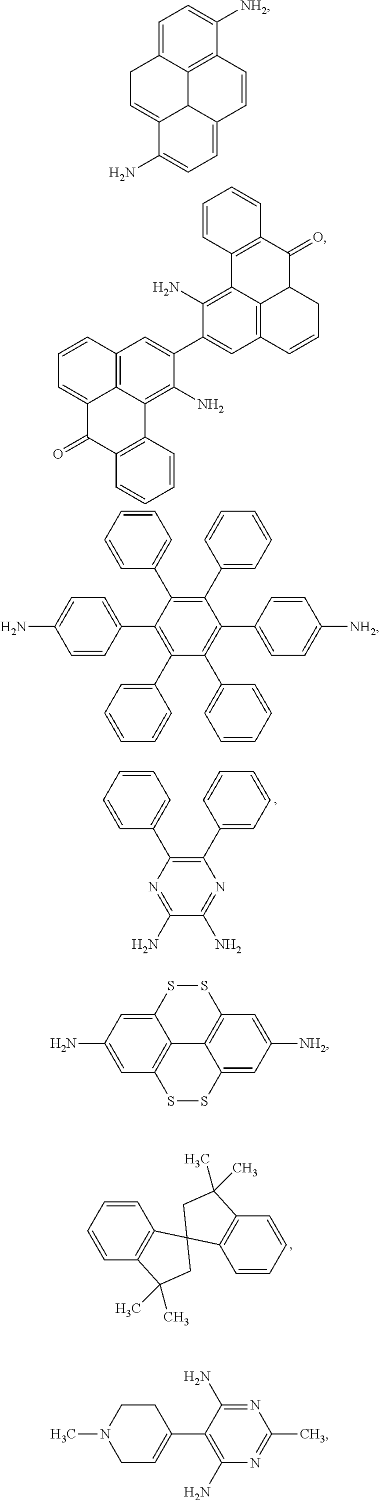 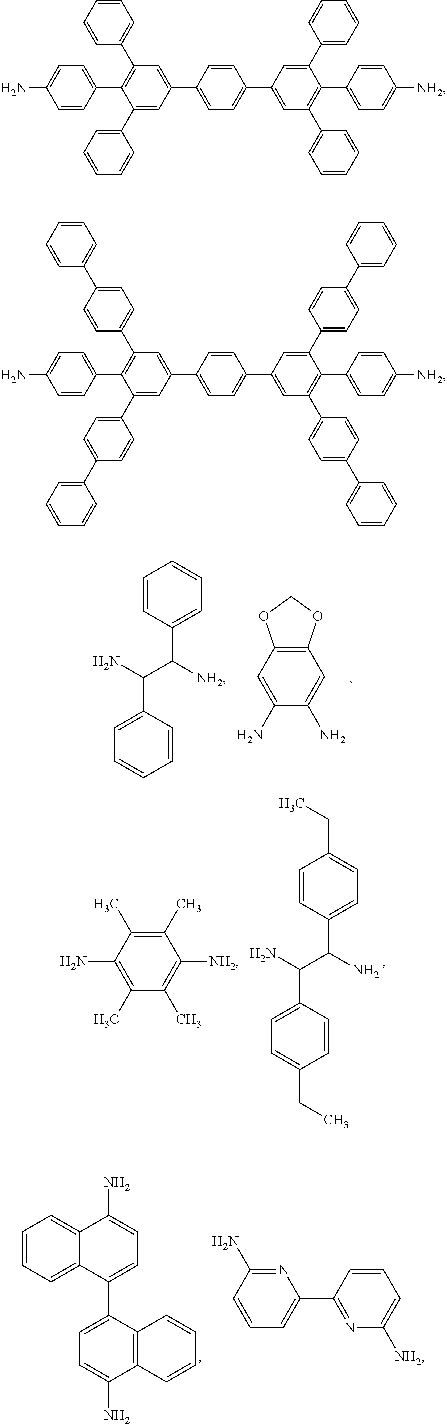
and combinations thereof.

4. The liquid crystal alignment agent as claimed in claim 1, wherein said diamine component (a) further includes at least one diamine compound (a-2) having a dipole moment larger than 2.8D.

5. The liquid crystal alignment agent as claimed in claim 4, wherein said diamine compound (a-1) is in an amount ranging from 20 moles to 80 moles based on 100 moles of said diamine component (a).

6. The liquid crystal alignment agent as claimed in claim 5, wherein said diamine compound (a-1) is in an amount ranging from 25 moles to 75 moles based on 100 moles of said diamine component (a).

7. The liquid crystal alignment agent as claimed in claim 6, wherein said diamine compound (a-1) is in an amount ranging from 30 moles to 70 moles based on 100 moles of said diamine component (a).

8. The liquid crystal alignment agent as claimed in claim 1, having surface tension ranging from 30 N/m to 60 N/m.

9. A liquid crystal alignment film formed from the liquid crystal alignment agent as claimed in claim 1.

10. The liquid crystal alignment film as claimed in claim 9, having a moisture content ranging from 2 wt % to 7 wt % based on 100 wt % of said liquid crystal alignment film.

11. The liquid crystal alignment film as claimed in claim 9, having surface specific resistivity not less than 5×10¹³Ω.

12. The liquid crystal alignment film as claimed in claim 11, wherein said surface specific resistivity ranges from 5×10¹³Ω to 1×10¹⁷Ω.

13. A liquid crystal display element, comprising the liquid crystal alignment film as claimed in claim 9.

14. The liquid crystal display element as claimed in claim 13, wherein said liquid crystal alignment film has a moisture content ranging from 2 wt % to 7 wt % based on 100 wt % of said liquid crystal alignment film.

15. The liquid crystal display element as claimed in claim 13, wherein said liquid crystal alignment film has surface specific resistivity not less than 5×10¹³Ω.

16. The liquid crystal display element as claimed in claim 15, wherein said surface specific resistivity ranges from 5×10¹³Ω to 1×10¹⁷Ω.
